(19) United States
(12) Patent Application Publication
(10) Pub. No.: US 2025/0149206 A1
(43) Pub. Date: May 8, 2025

(54) HIGH PERFORMANCE INJECTION CONNECTOR FOR FLOW-RESTRICTED CABLE

(71) Applicant: Southwire Company, LLC, Carrollton, GA (US)

(72) Inventors: Weston Philips Chapin Ford, Seattle, WA (US); Norman E. Keitges, Renton, WA (US); James Steele, Kent, WA (US)

(21) Appl. No.: 18/939,412

(22) Filed: Nov. 6, 2024

Related U.S. Application Data
(60) Provisional application No. 63/547,719, filed on Nov. 8, 2023.

(51) Int. Cl. H01B 13/32; H01B 13/06

(52) U.S. Cl. CPC H01B 13/322; H01B 13/06

(57) ABSTRACT

A connector for injection of cable treatment fluid having an injection adapter with a first adapter portion attachable to the free-end portion of the cable insulation using compression and a second adapter portion attachable to the cable electrical connector, and a flow channel positioned within the injection adapter between the first adapter portion and the electrical conductor, with a flow channel outward end located toward the outward end portion of the first adapter portion and a flow channel inward end located toward the inward end portion of the first adapter portion, such that when the first adapter portion is attached to the free-end portion of the cable insulation using compression, the flow channel will provide a flow path for injected treatment fluid through at least a portion of a compression zone created by the first adapter portion.

### BACKGROUND OF THE INVENTION

### Field of the Invention

The present invention relates to silane injection of solid dielectric medium-voltage power cables manufactured with flow-restricted conductors.

### Description of the Related Art

Power cables are generally constructed by a metallic conductor surrounded by polymeric insulation. For the purpose of illustration, a medium voltage power cable 100 is shown in FIG. 1. Typical construction for the medium voltage power cable 100 comprises a conductor 102 made of aluminum or copper. Often the conductor 102 will be comprised of multiple individual conductor strands 104 that are arranged in concentric layers. The space between the individual conductor strands is known as interstitial volume 106. Surrounding the conductor is a conductor shield 108, a semi-conducting layer often included in the design of medium and high-voltage power cables to reduce electrical stress in the insulation. Surrounding the conductor or conductor shield is insulation 110 that has a substantial dielectric strength and is typically made of polyethylene (PE), cross-linked polyethylene (XLPE) or ethylene-propylene rubber (EPR). Surrounding the insulation 110 is an insulation shield 112, a second semi-conducting layer often included in medium and high-voltage power cables to reduce electrical stress in the insulation. Surrounding the insulation shield 112 is a ground 114 used to carry stray current and drain capacitive charge from the cable. The ground 114 may consist of multiple conductors arranged circumferentially around the cable called concentric neutrals 116. The outermost layer of the cable is the optional jacket 118 that provides mechanical protection to the cable. The construction of medium-voltage cable rated from 5 kV to 46 kV is further described in ICEA S-94-649-2000. While a medium voltage power cable with a jacketed concentric neutral construction has been shown, it should be appreciated that other forms of power cable exist, such as bare-concentric cable, tape-shield cable, low voltage cable, armored cable, submarine cable and high-voltage cable. Such cables may see the addition of elements such as armor or the subtraction of elements such as semi-conductive shields or neutrals. There are a number of phenomena that can “age” medium-voltage cable insulation. The most damaging of these is the diffusion of water from the ground through the jacket and insulation shield and into the insulation. Once in the insulation, the water can oxidize the PE, XLPE or EPR and result in a phenomenon known as water treeing occurring. [Steenis E.F. (1989) Water treeing the behavior of water trees in extruded cable insulation, 201p]. These water trees look like microscopic trees in the insulation, and they can grow from either of the two semi-conductive shields or can initiate within the insulation and grow radially towards the semi-conductive shields in the shape of a bowtie. Left untreated, these “water trees” grow in the insulation and lead to premature cable failure. The life of the cable in the ground is directly related to the health of the insulation layer.

The space between the conductor strands is known as the interstitial region. First practiced in the 1980's, cable rejuvenation increases the cable insulation's dielectric strength by injecting water reactive alkoxysilanes into the interstitial region of the conductor [U.S. Pat. Nos. 7,615,247 and 7,611,748]. The fluid traverses from the near end of the cable to the far end of the cable. The fluid then diffuses radially from the interstitial region into the insulation. The fluid raises the dielectric strength of the insulation and reacts with water, effectively treating the water trees. As it reacts, the fluid becomes an oligomer decreasing its rate of diffusion by orders of magnitude, allowing the fluid to dwell in the cable for an extended period of time. Treating these water trees increases the remaining life of the cable by many years.

The typical injection process is as follows. The cable is de-energized and new terminations are placed on each end. The cable is checked for neutral condition and a slight positive flow of air is placed on the cable to ensure flow from one end of the cable to the other. The cable is then injected with the treatment fluid from the near end, and when the fluid arrives at the far end and fills the interstitial region, the cable is considered injected and is put back in service. Today, there are two primary methods of cable rejuvenation in commercial practice with both being well documented in literature [Banerjee, et al, “Cable Rejuvenation Practices”, CEATI Report No. T154700-50/129, November 2017].

The first method known as improved un-sustained pressure rejuvenation (iUPR) relies on a continuous flow path being present in the conductor and uses it as the reservoir to house the injection treatment for treating the insulation. This method has been well described in literature, including U.S. Pat. Nos. 4,766,011 and 5,372,841.

The second method known as sustained pressure rejuvenation (SPR) creates additional interstitial volume through elastic expansion and increases flow rate due to the use of moderate pressure [U.S. Pat. Nos. 7,615,247 and 7,611,748]. Referring to FIG. 2, cable 200 is comprised of a conductor 202, a conductor shield 204 and an insulation 206. Conductor 202 is comprised of 7 conductor strands for example and defined by perimeter 208 in its initial state. When a pressurized fluid is injected into the cable, the cable expands radially. In its pressurized state, the interstitial volume 212 is increased. Conductor shield 204 is defined by perimeter 214 along the surface of the conductor and perimeter 220 adjacent to the insulation. In its pressurized state, conductor shield 204 is defined by perimeters 216 and 222. In this state, additional volume 218 is created between the conductor and conductor shield that can be used for injection. The insulation's outer surface is defined by perimeter 224 in the initial state and perimeter 226 in the pressurized state.

Following the SPR method, injection adapters (IA's) are typically installed at the cable terminations to create a fluid seal. Referring to FIG. 3A, cable termination 300 is first comprised of injection adapter 320 that is appreciably cylindrical in shape and contains an injection port 326 allowing an open fluid path to the internal volume of the injection adapter. An injection adapter 320 is comprised of two ends 322 and 324. End 322 is intended to receive cable 302. Cable 302, comprised of insulation 304 and conductor 306, is passed partially through injection adapter 320 so that the insulation is partially covered by end 322. Cable connector 308 is inserted into end 324 and makes electrical contact with conductor 306. Referring now to FIG. 3B, the ends 322 and 324 of injection adapter 320 are compressed or swaged onto cable 302 and connector 308. The injection adapter material is typically either 303 Stainless Steel or Aluminum and restricts the radial expansion at the cable at the termination relative to midspan.

Further process enhancements were disclosed in U.S. Pat. No. 8,572,842 includes the application of thermally enhanced rejuvenation (TER) to create interstitial volume through a combination of thermal expansion at an elevated temperature and elastic expansion due to a moderate pressure.

Some cables may become flow-restricted due to corrosion of the conductor associated with moisture ingress or be manufactured with flow-restricted conductors including a single solid-strand conductor, compact stranded conductor, and water-absorbing or strand-filling compounds.

In the 1980's, cable manufacturers began incorporating strand-filling compounds into the conductors of medium voltage cable that filled the interstitial spaces and restricted water migrating along the length of cable. Strand-filling materials are typically formulations comprised of polyisobutylene (PIB) and carbon black filler to help smooth the electrical field. Today, with few exceptions, all strand-filling compounds are a mastic manufactured by Chase Corporation as Chase A162A BIH2Ock. It easily passes industry standard tests (like ICEA T31-610) and has been used successfully for more than 25 years. According to industry surveys, almost 90% of medium voltage cables manufactured today have strand-filled conductors. However, field experience shows strand blocked cables perform similarly to non-strand filled cables of like construction and vintage in terms of AC-breakdown performance and are still susceptible to water-tree aging and failures. Hence, cable rejuvenation is still a desirable option to maintain reliability of electrical grid.

Due to the shortage of free interstitial volume in strand-blocked cable, lack of continuous flow path and physical properties of the strand block material, new methods of cable rejuvenation had to be created and have been previously disclosed in U.S. Ser. No. 17/459,867 and others. These methods detail the selection of injection fluids to match solubility of the strand-block material with elevated temperatures and pre-injection of compressed gasses to alter the physical properties of the strand-block mastic material to create a continuous flow path for injection.

Recent methods of termination preparation for flow-restricted cables include a standard injection adapter which is compressed (swaged) onto the cable insulation and conductor to create a fluid seal as well as an electrical connection between the conductor and connector. The conductor is prepared by spreading some of the outer layer of conductor strands, cleaning the strand blocking material from them using a wire brush, and wrapping a small gauge aluminum wire around the inner conductor strands. This is roughly the same process used for cables which are not strand blocked, but with more robust cleaning of the outer strands.

In field and lab practice, injection durations are often inconsistent between locations, cable brands, and environmental conditions. While nearly 100% of strand blocked cables using PIB-based strand block mastic are injectable, the duration of pretreatment and injection is sometimes too long for field practicality under certain conditions and logistical constraints. In practical field conditions, one line crew can inject about two strand-blocked URD segments per day on average, assuming that the segments can be left injecting while unattended overnight. In other locations and environments, productivity can be below one segment per day due to the long times required to pretreat and inject the cable. Additionally, it has been noted that some cable brands appear to inject more quickly than others of the same geometry or require less heat for the pretreatment process.

Lab testing has shown that temperature has a significant effect on the ability of the terminations to begin flowing. Referring to FIG. 4, lab results collected from short cable samples of less than 12″ of conductor length with a standard termination on each end to flow CO2 gas at standard pressures used for pretreatment. The intent of the short samples is to minimize the midspan effects and focus primarily on the performance of the terminations. The results clearly show that temperature has a significant effect on the delay between pressure application to the sample and continuous flow through the sample. This strong dependance on the termination performance may explain some of the seasonal differences or other possible variations in pretreatment and injection time observed in the field. While each cable is heated to the same temperature calculated as an average along its length, the termination temperature is influenced by many more factors including contact resistance, ambient temperature, wind speed, and solar radiation that are not easily controlled for the average cable. Most importantly, this result indicates that the cable midspan may not be exposed to the pretreatment gas flow for tens of minutes, delaying the total pretreatment time, and that time can be variable if the termination temperature is not closely controlled.

It is a current practice to prepare the strand blocked terminations using several wraps of small gauge aluminum wire between the outermost conductor strands and inner strands. The outer strands and outside of the inner strand bundle are also cleaned to remove any strand block mastic using a wire brush. Both efforts are intended to reduce the flow restriction at the termination, although recent lab testing has shown no benefit of strand cleaning.

Based on these results and field experience, it seems clear the cable termination represents a significant barrier to flow, and likely increases injection time while being relatively difficult to control with the currently practiced process. There exists a need for an improved cable termination to inject flow-restricted cable.

### BRIEF DESCRIPTION OF THE SEVERAL VIEWS OF THE DRAWING(S)

FIG. 1 is a perspective view of a medium voltage prior art power cable.

FIG. 2 is a sectional end view of another prior art power cable.

FIG. 3A is a sectional side view a prior art cable termination.

FIG. 3B is an elevational side view of the prior art cable termination of FIG. 3A.

FIG. 4 is a graph showing lab results showing the impact of temperature of prior art termination flow.

FIG. 5 is an elevational side view of an injection connector of the present invention illustration the compression zone.

FIG. 6A is a sectional side view of a first embodiment of the injection connector of the present invention.

FIG. 6B is an enlarged, fragmentary, sectional side view of the injection connector of FIG. 6A.

FIG. 6C is an enlarged, sectional end view of the injection connector of FIG. 6A.

FIG. 7A is a sectional side view of a second embodiment of the injection connector of the present invention.

FIG. 7B is a perspective view of an annular drill bit used in the preparation of a cable for use of the injection connector of FIG. 7A.

FIG. 7C is an elevational side view of an electric drill with the annular drill bit of FIG. 7B used to prepare the cable for use with the injection connector of FIG. 7A.

FIG. 7D is an elevational side view of an electric drill with the annular drill of FIG. 7B used cutting an annular hole to receive a collar of the injection connector of FIG. 7A.

FIG. 7E is a side elevational view of the cable with the collar inserted into the annular hole cut in FIG. 7D.

FIG. 8A is a sectional side view of a third embodiment of the injection connector of the present invention.

FIG. 8B is an enlarged, sectional end view of the injection connector of FIG. 8A.

FIG. 8C is perspective view showing a pressed collar of the injection connector of FIG. 8A installed on a conductor strand bundle.

FIG. 8D is perspective view showing the pressed collar of FIG. 8C used on a conductor strand bundle with a larger diameter.

FIG. 8E is a side elevational view of a partially assembled injection connector of FIG. 8A illustration heating of the cable to facilitate installation of the injection connector of FIG. 8A.

FIG. 9 is a sectional perspective view of a fourth embodiment of the injection connector of the present invention.

FIG. 10A is a schematic diagram of a system for testing the flow of sample injection connectors.

FIG. 10B is chart showing the results of tests using the test system of FIG. 10A.

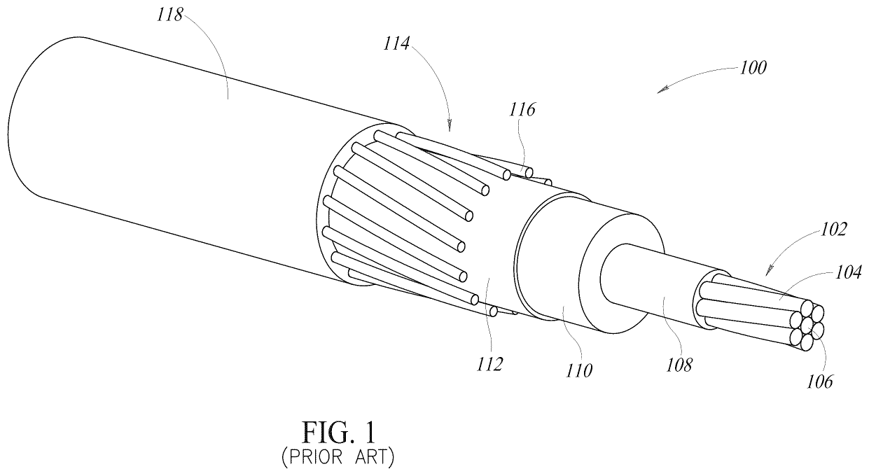

Like reference numerals have been used in the figures to identify like components.

### DETAILED DESCRIPTION OF THE INVENTION

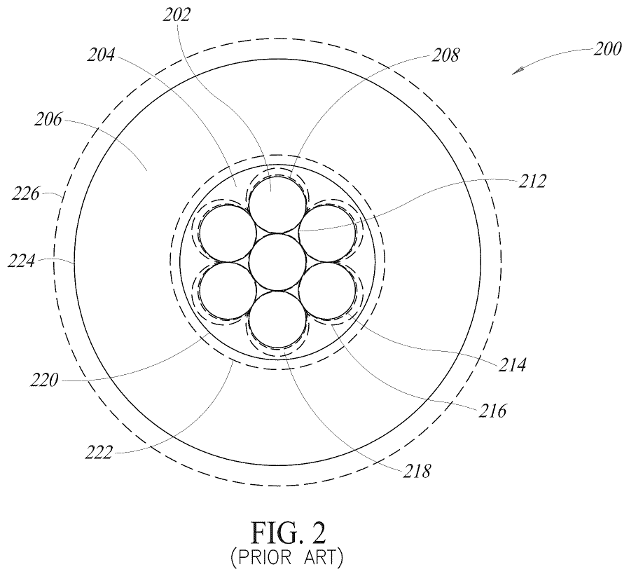

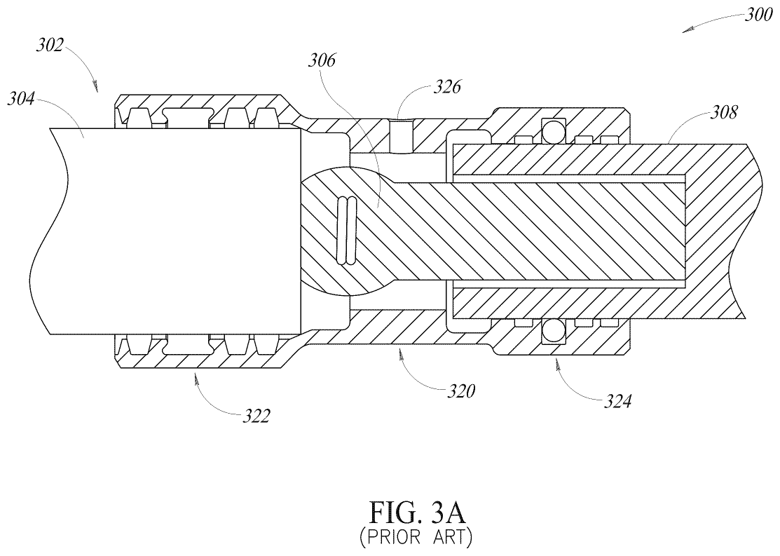

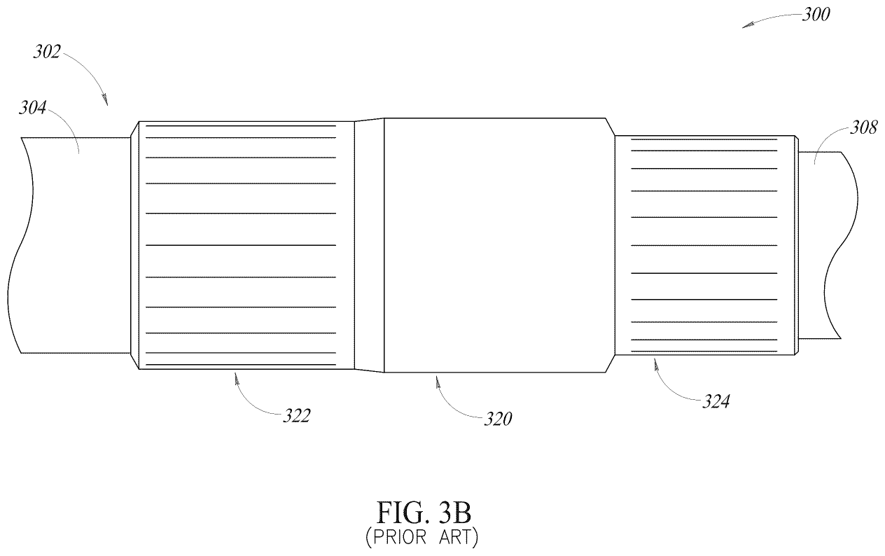

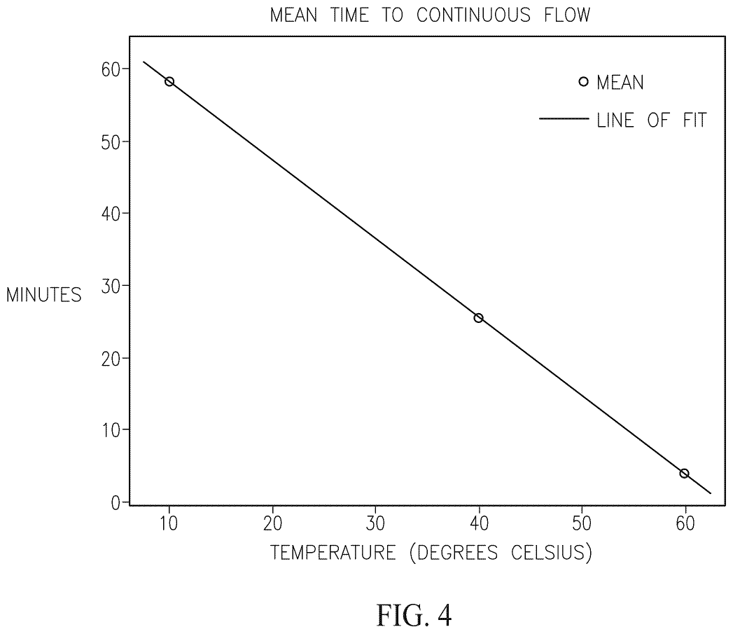

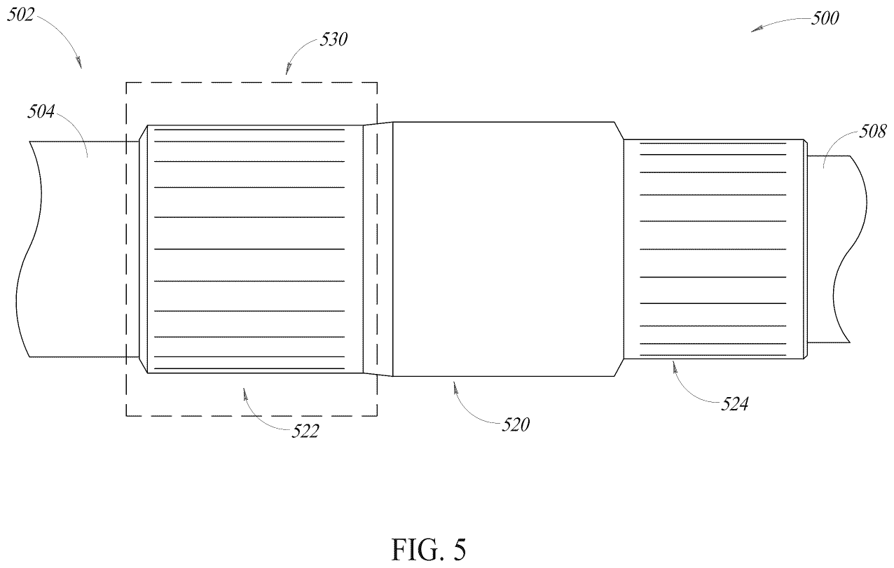

For flow-restricted cable, like cable with corroded conductors or manufactured with PIB-based strand-block mastic, results of testing have shown that the primary flow path at midspan of the cable is around the outside of the conductor and not inside the interstitial regions between conductor strands. Referring again to FIG. 2, additional volume 218 is created between the conductor and conductor shield when the cable is in its pressurized state. This flow path is created along the cable length. However, at the cable terminations insulation's perimeter 224 is unable to expand radially and flow is restricted at the terminations. This is also illustrated in FIG. 5 for injection connector 500. FIG. 5 is substantially similar to FIG. 3A and 3B except for compression zone 530 that represents the location of flow restriction where the cable insulation 504 of cable 502 is prevented from radially expanding by the rigid material of injection adapter 520. The mostly cylindrical injection adapter 520 includes of ends 522 and 524 that are swaged or compressed onto the cable insulation 504 and an electrical connector 508, respectively.

In the compression zone 530, testing has indicated that that the primary flow path of the injection fluid is forced to flow through the conductor strand interstices that is severely restricted by strand-block mastic or other blockages in flow-restricted cable. A more ideal termination would see this restriction due to compression be reduced beyond what is currently practiced.

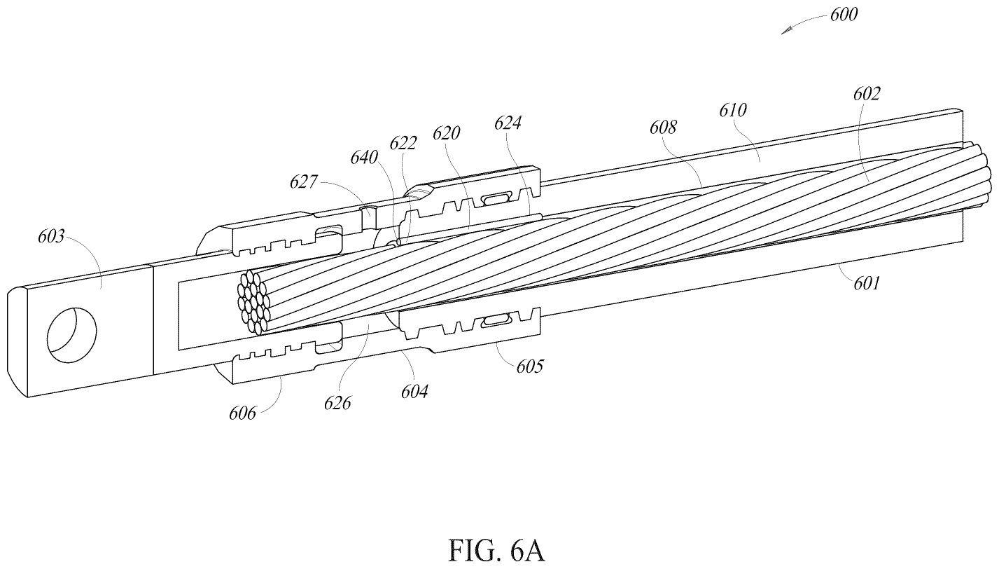

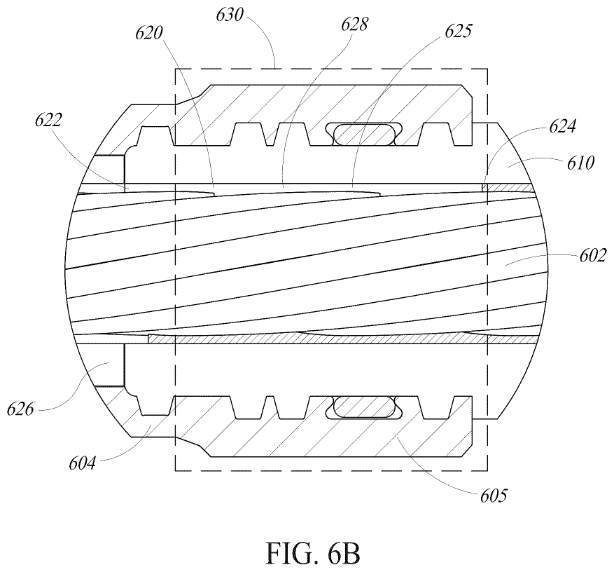

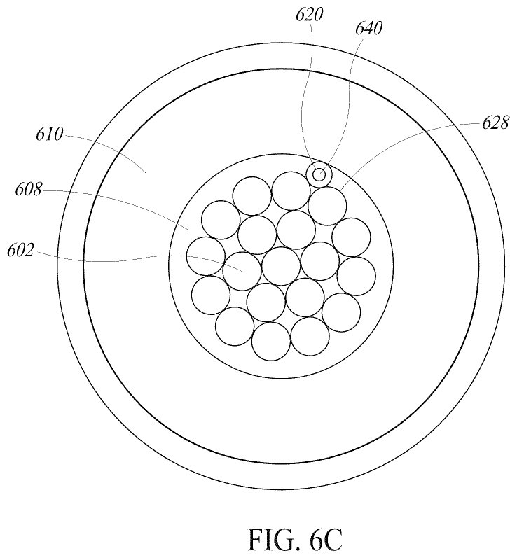

A first embodiment of the high-performance injection connector 600 for connecting a flow-restricted cable 601 to an electrical connector 603 is shown in FIGS. 6A, 6B, and 6C. A mostly cylindrical injection adapter 604 includes ends 605 and 606 that are swaged or compressed onto the cable insulation 610 of the cable 601 and an electrical connector 603, respectively. The high-performance injection connector is comprised of a flow tube 620, which includes a first open end 622 and a second open end 624 with a channel extending therebetween, so that fluid flow can pass through the flow tube. The flow tube is installed between the outer surface of the conductor strand bundle 602 and the inner surface of the conductor shield 608 or the insulation 610. The first open end 622 is nearest to a terminal end of cable 601 at which the electrical connector 603 is located, and the second open end 624 is nearest to the cable midspan. As shown in FIG. 6A, the second open end 624 of the flow tube may be beveled to aid is pressing the flow tube 620 into the cable like a needle. Alternatively, as shown in FIG. 6B, the second end 624 of the flow tube 620 may have a blunt end which may be placed into a drilled hole 625 provided between the outer surface of the conductor strand bundle(s) 602 and the inner surface of the conductor shield 608 or the insulation 610.

The flow tube 620 is mostly crush resistant and is constructed of stainless steel, copper, brass, aluminum alloy, carbon fiber or similar material. The length of the flow tube is such that the first open end 622 is in unrestricted fluid communication with a cavity 626 into which injection fluid can flow through an injection pin hole 627. The second open end 624 of the flow tube extends partially or fully through the compression zone 630 of the injection adapter 604. The flow tube 620 should have an inner diameter of at least 0.010 inches. The flow tube should have an outer diameter and placement such that no more than 57% of the thickness of the insulation 610. In this embodiment, the flow tube is installed prior to swaging the end 605 of the injection adapter 604 onto the cable insulation 610. The flow tube 620 allows a flow channel to remain mostly unrestricted through the compression zone between the conductor strand bundle 602 and the conductor shield 608 by allowing fluid to flow readily into the additional volume created by the injection of pressurized fluid into the cable beyond the compression zone between the conductor strand bundle and conductor shield.

FIG. 6C is an end view of the installed injection adapter 604 showing the second open end 624 of the flow tube 620 positioned along or near the interface 628 between the conductor strand bundle 602 and the conductor shield 608 or the insulation 610. The flow tube provides a fluid flow path 640 extending the length of the flow tube which allows fluid to flow with little restriction through the compression zone 630.

The flow tube may alternatively be integrated into the injection connector rather than a separate component. The flow tube may also be placed into the conductor bundle so that it spirals between the lay of the strands.

As another alternative, a hole could be drilled following compression of the injection adapter onto the cable insulation. In this alternative, the flow channel would bypass the flow-restricted compression zone created by the swage altogether.

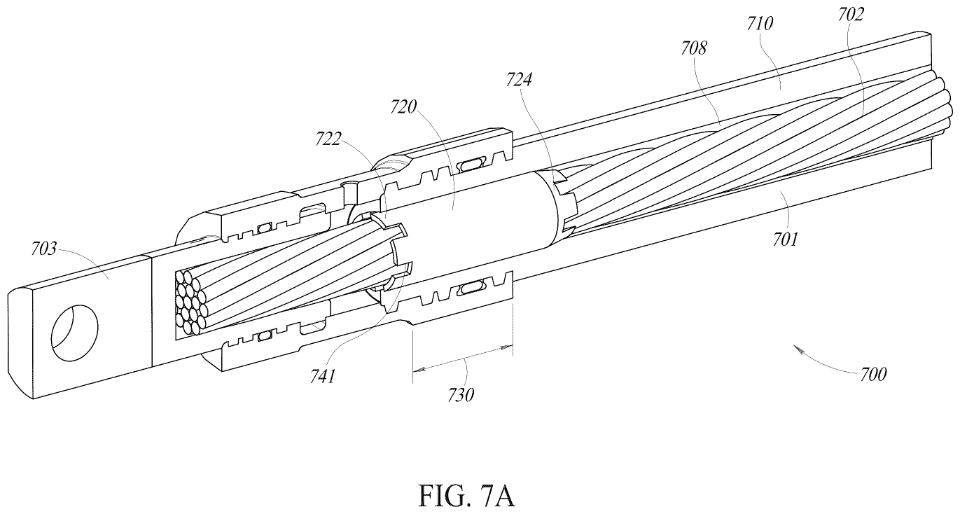

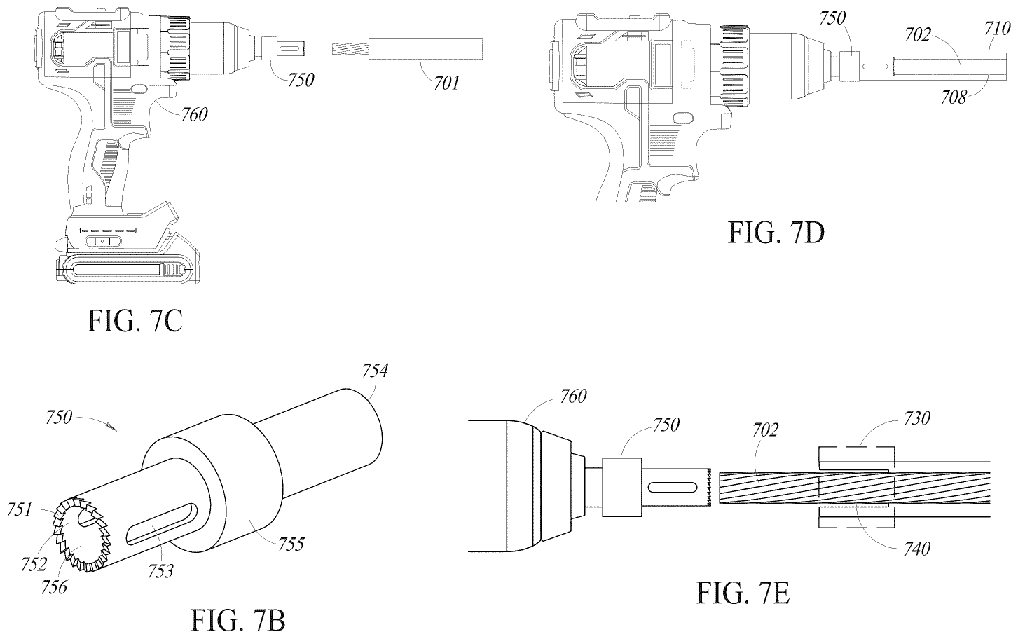

A second embodiment of a high-performance injection connector 700 for connecting a flow-restricted cable 701 to an electrical connector 703 is shown in FIG. 7A. The injection connector includes a collar 720 which is generally a hollow cylinder and incudes a first end 722 which is closest to the terminal end of the cable at which the electrical connector 703 is located, and a second end 724 which is closest to the cable midspan. The collar 720 is installed between a conductor strand bundle 702 and a conductor shield 708 or an insulation 710 of the cable. It is desirable that the collar 720 be arranged concentric with and adjacent to the conductor strand bundle 702. The collar 720 is mostly crush resistant and constructed of stainless steel, copper, brass, aluminum alloy, filled plastic, carbon fiber or similar material. The collar 720 is sized to slip over the conductor strand bundle 702 of the cable and should and have a wall thickness of at least 0.010 inches. The collar 720 optionally includes one or more notches 741 on both ends 722 and 724 which reduce flow restriction when butted up against the insulation 710 or connector 703. An injection connector similar to that described in FIG. 5A is installed over the cable and swaged onto the insulation 710. The collar resists radial compression and maintains a longitudinal flow path along the conductor strand bundle 702 through the flow-restricted compression zone 730 of the injection connector. Optionally, the second end 724 of the collar 720 may have a taper to ease installation.

Referring to FIGS. 7B, 7C, 7D, and 7E, the collar 720 described above may be installed by first drilling an annular hole 740 in the insulation 710 which extends partially or fully through the zone of compression zone 730 using an annular drill bit 750. The annular drill bit 750 is used to remove conductor shield 708 and insulation material 710 around the conductor strand bundle 702 and thereby allow the collar 720 to be slipped into the annular hole 740. The annular drill bit 750 is comprised of a first end 752, with opening 756 sized to slip over the conductor strand bundle 702 and which axially centers the annular drill bit. The first end 752 is comprised of at least two cutting teeth 751 and optionally may contain at least one chip relief slot 753 which aids in evacuating the material removed during the drilling process. The annular drill bit 750 may also contain a chamfer on the inside surface of the cutting teeth 751 to minimize contact with the conductor strand bundle 702 while cutting. The annular drill bit 750 is comprised of a second end 754 which accepts a device to impart torque and axial force to the annular drill bit 750 such as an electric drill 760 or manual handle. Optionally, the annular drill bit 750 may include a physical stop 755 to limit the depth of the annular hole 740 to the desired depth. This stop 755 can be integral to annular drill bit 750 and fixed, captive but adjustable, or a separate part which is adjustable and not captive.

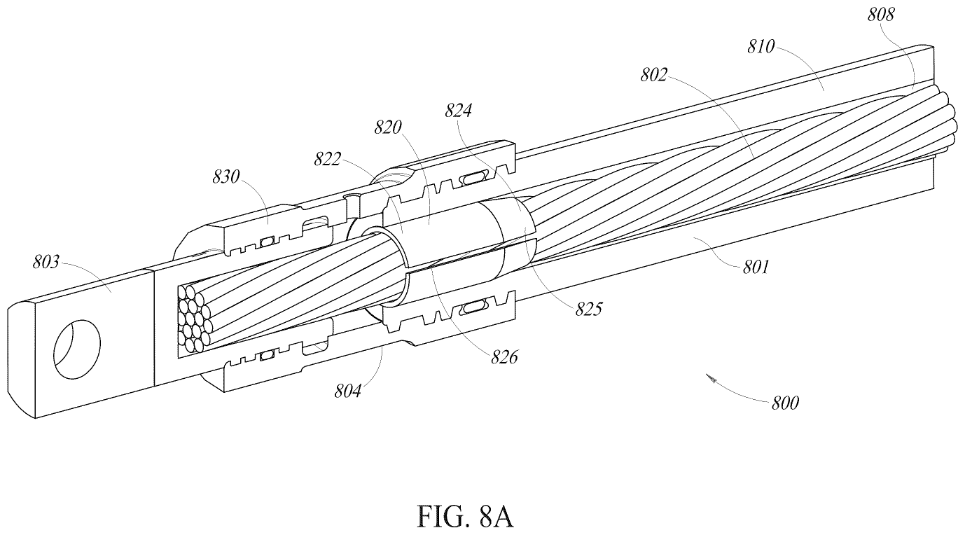

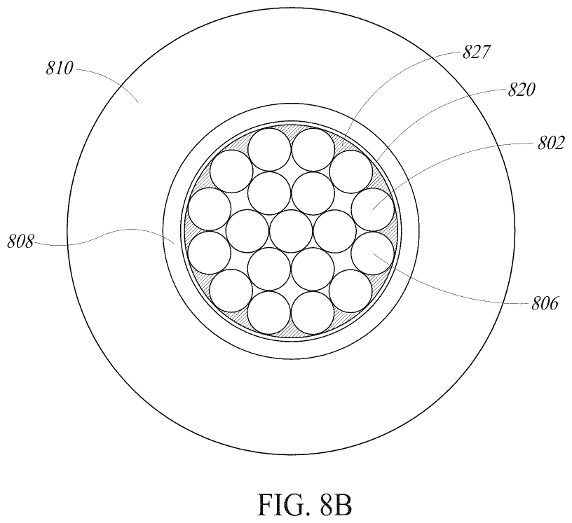

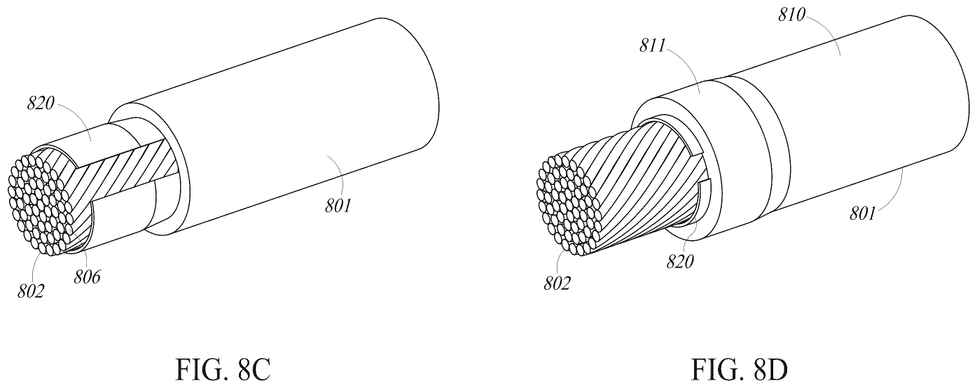

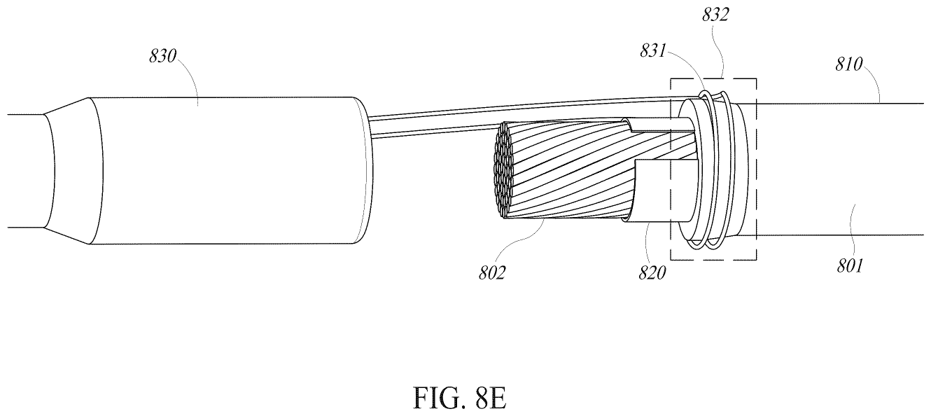

A third embodiment of the high-performance injection connector 800 for connecting a flow restricted cable 801 to an electrical connector 803 is shown in FIGS. 8A and 8B. The high-performance injection connector includes a mostly cylindrical injection adapter 804 and includes a pressed collar 820 that slips over a conductor strand bundle 802 and is pressed into the cable so that it lifts the insulation 810 and the conductor shield 808 away from conductor strand bundle 802. The pressed collar 820 is generally a hollow cylinder and comprises a first end 822 which is closest to the terminal end of the cable at which an electrical connector 803 in located, and a second end 824 which is closest to the cable midspan. The pressed collar 820 is mostly crush resistant and constructed of stainless steel, copper, brass, aluminum alloy, filled plastic, carbon fiber or similar material. The second end 824 of the pressed collar 820 optionally includes a chamfer 825 to reduce the force required for installation and may optionally have a longitudinal slot 826 which allows the pressed collar 820 to better conform to the conductor strand bundle 802 and additionally reduces flow resistance. The slot 826 is a longitudinal split allowing the cross-sectional size of the collar to be increased to accommodate multiple diameter size conductor strand bundles. The pressed collar 820 is sized to slip over the conductor strand bundle 802 of the cable and has a wall thickness of at least 0.005 inches. The pressed collar is designed to separate the conductor bundle 802 from the conductor shield 808 in the immediate vicinity of the pressed collar 820. An injection connector 830 substantially similar to that described in FIG. 5A is installed over the cable and swaged onto the cable insulation 810.

FIG. 8B is an end view of the installed injection adapter 804 and illustrates how the pressed collar 820 resists radial compression and maintains a longitudinal flow path in the volume between the outer shell of conductor strands 806 of the conductor strand bundle 802 and the pressed collar 820 extending fully or partially through the flow-restricted compression zone of the injection adapter 804.

The pressed collar 820, which is shown pre-installation in FIG. 8C, may be used on larger diameter conductors with an increased number of strands in the conductor strand bundle 806.

As shown in FIG. 8D, the pressed collar 820 creates an increase in the outside diameter 811 in the insulation 810 since no material is removed during the pressed collar 820 installation process. This increase in the outside diameter 811 of insulation 810 may result in a larger injection adapter than is typical for the cable geometry. Heat may be applied to the cable to warm the cable insulation 810 and reduce the force required to insert the pressed collar 820. This heat may be applied with an inductive heater 830 to region 832 of cable 801, as shown in FIG. 8E. The heater 830 comprises an inductive coil 831, which warms the conductor strand bundle 802 and pressed the collar 820 directly, which then conducts heat to the insulation 810, temporarily softening it in the region 832. A portable heat source such as a torch or electric heat gun, or an oven-type heater which surrounds the termination and raises the gas inside to a set temperature could also be used to achieve the same effects of heating cable insulation 810.

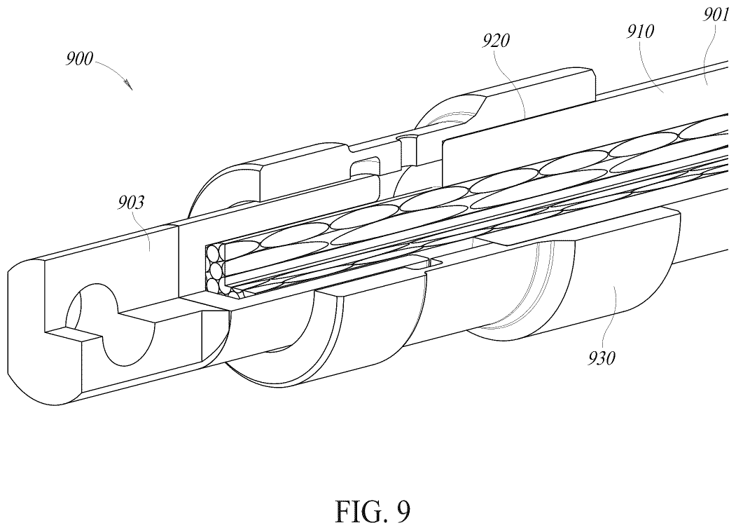

Referring to FIG. 9, a fourth embodiment of the high-performance injection connector 900 for connecting a flow-restricted cable 901 to an electrical connector 903 is shown. The high-performance injection connector includes a compressionless seal 920 on the cable insulation 910. The compressionless seal 920 is made by applying glue between the inner surface of the injection connector 930 and the outer surface 911 of the cable insulation 910. Glue may include 3M Scotchweld DP 8005, 30 Scotchweld DP 8010 or similar glue appropriate for boding polyethylene or EPR to aluminum or stainless steel 303. The termination restriction is reduced by sealing against the cable insulation 810 without using an adapter or connector which compresses the insulation. The inner surface of the injection connector may be knurled, threaded. grooved. or tapered to create an additional surface to bond to the cable insulation 810.

The inventions described above are also applicable to flow restricted cables having a single solid-strand conductor, in other words to cables with one or more conductor strands.

### Test

A test was completed to quantify the performance of 4 high performance terminations for flow restricted cable using carbon dioxide gas which was flowed through a short sample of cable terminated with each of the 4 termination types discussed above.

A field aged Pirelli 1996 1/0 AWG cable with an insulation thickness of 220 mil and a conductor filled with a polyisobutylene based strand blocking mastic was used for test samples. Three samples of each termination type were tested.

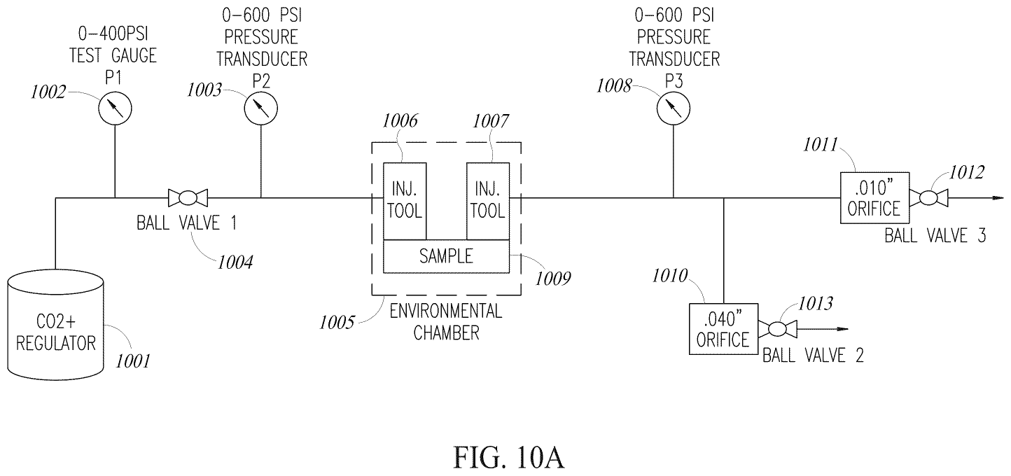

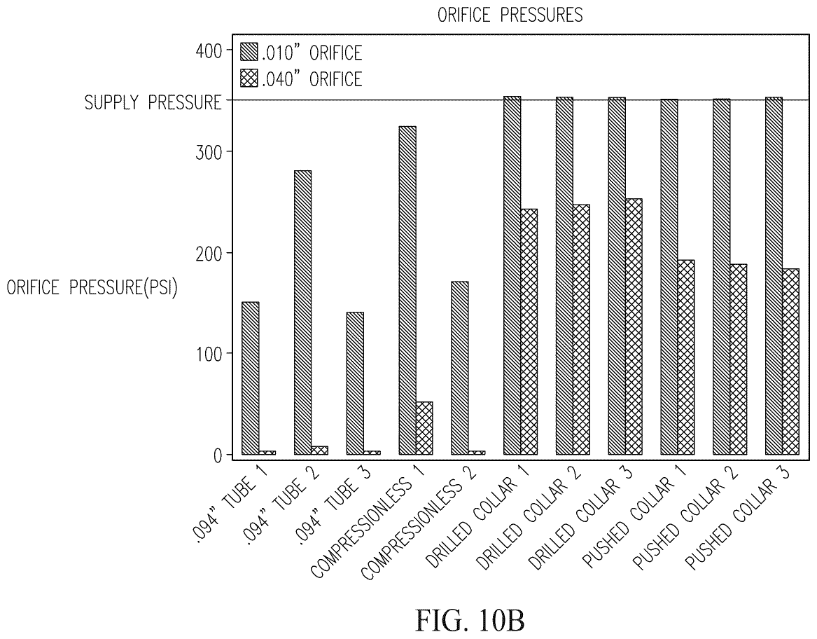

Referring to FIG. 10A, a means to control and measure the parameters of the test was used to measure the time to first continuous flow and the steady flow rate through all samples. The test fixture consisted of a carbon dioxide supply and pressure regulator 1001. The outlet of the pressure regulator 1001 was in fluid communication with a first pressure measurement device 1002 which was used to measure the gas pressure. A first ball valve 1004 was used to manually control the flow of gas from the regulator 1001. The ball valve 1004 was in fluid communication with a second pressure transducer 1003 which was used to electronically record the gas supply pressure. The gas supply was in fluid communication with a first injection tool 1007 which was used to supply pressurized gas to the cable sample 1009. The opposite end of the cable sample 1009 had a similar injection tool 1007 which was used to receive gas flow from the cable sample 1009. The second injection tool 1007 was in fluid communication with a third pressure transducer 1008 which measured the pressure between the second injection tool 1007 and the orifices 1011 and 1010. Flow through the smaller orifice 1011 or the larger orifice 1010 was controlled using the ball valves 1012 and 1013, respectively. The larger orifice of 0.040″ size was used to achieve a more sensitive measurement when the sample 1009 had a low flow resistance, while the smaller orifice 1011 was used to achieve a more sensitive measurement when the sample 1009 had a relatively high flow resistance. The sample 1009, first injection tool 1006 and second injection tool 1007 were contained within an environmental chamber 1005 where temperature was controlled.

When each sample 1009 was tested, the 0.010″ orifice 1011 was used first since it is the most sensitive for detecting low flows and time to first continuous flow. The 0.010″ orifice 1011 pressure was often near the supply pressure, indicating that the restriction of the orifice was large compared to that of the sample 1009 and plumbing system. The 0.040″ orifice 1010 pressure was then recorded for each sample 1009, which gave better resolution for the high flow samples. There were no cases where the 0.040″ orifice 1010 pressure neared the supply pressure, although it is notable that the supply pressure was often dragged down by the high flow through some of the samples when using the 0.040″ orifice 1010. This is evident in Table 2 where supply pressures with the 0.040″ orifice 1010 sometimes near 20 psi lower than the same conditions measured with the 0.010″ orifice 1011 and is due to a combination of the regulator 1001 and tubing resistance upstream of the supply pressure transducer 1003.

Referring to FIG. 10B, the annular drill with flow collar is consistently the highest performing treatment, followed closely by the pressed flow collar. The threaded end seal and 0.094″ tube are both more inconsistent and have lower average flow rates (indicated by lower orifice pressure). All pressed collar and annular drill with collar samples flowed in less than 1 second from gas pressure being applied. The longest of the 0.094″ tube samples took 6 seconds, and the longest of the threaded end samples took 1 second. The GL240 was sampling at 1 sample per second so times less than 1 second could not be measured.

The Table below shows the mean orifice pressures and coefficients of variation for each sample at each orifice size. For the high performing samples, the 0.040″ orifice values are most meaningful, where the 0.010″ orifice values are more meaningful when they do not approach the supply pressure. Additionally, the volumetric gas flow rate was calculated according to published formulas relating the pressure across an orifice of given dimensions to volumetric flow for each sample as well as a control using existing termination preparation techniques. The ratio of these volumetric flow calculations is shown in the rightmost column in the table, indicating that the flow performance of all tested treatments is between 2.4 and 48 times that of the control. The time to first continuous flow is between greater than 3858 times faster than the control and greater than 1450 times faster, however the exact ratio cannot be calculated since most samples tested flowed in less than one second and the pressure sampling rate was 1 sample per second.

| | | | | | Volumetric | Time to First |
|---|---|---|---|---|---|---|
| | | | | | Flow Ratio | Continuous |
| | | | | | Compared | Flow Ratio |
| | .010″ Orifice | | .040″ Orifice | | to Control | Compared to |
| | Mean (psi) | CV | Mean (psi) | CV | Sample | Control |
| Control Sample | 62.8 | 34% | n/a | n/a | 1 | 1 |
| Pressed Collar | 351.6 | 0.27% | 188.0 | 1.80% | 37.1 | >3858 |
| Annular Drill | 352.7 | 0.10% | 247.3 | 1.72% | 48.0 | >3858 |
| Collar | | | | | | |
| Flow Tube | 190.4 | 33.56% | 4.2 | 55.85% | 2.4 | >1450 |
| Compressionless | 247.9 | 30.86% | 28.3 | 83.18% | 7.2 | >3858 |
| Connector | | | | | | |
| | | | | | Average | Average Time |
| | | | | | Volumetric | to First |
| | .010″ Orifice | | .040″ Orifice | | Flow | Continuous |
| | Mean (psi) | CV | Mean (psi) | CV | (SLPM) | (seconds) |
| Control Sample | 62.8 | 34% | n/a | n/a | 2.8 | 3858 |
| Pressed Collar | 351.6 | 0.27% | 188.0 | 1.80% | 103.9 | <1 |
| Annular Drill | 352.7 | 0.10% | 247.3 | 1.72% | 134.3 | <1 |
| Collar | | | | | | |
| Flow Tube | 190.4 | 33.56% | 4.2 | 55.85% | 6.7 | <2.6 |
| Compressionless | 247.9 | 30.86% | 28.3 | 83.18% | 20.1 | <1 |
| Connector | | | | | | |

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

1. An injection connector for injection of a treatment fluid for rejuvenating a flow restricted cable having an electrical conductor comprised of a plurality of conductor strands with interstitial volume therebetween blocked by a PIB-based mastic or another restriction, the electrical conductor being surrounded by a polymeric cable insulation and having a free-end portion extending outward beyond a free-end portion of the cable insulation for attachment to an electrical connector, comprising:
an injection adapter having a first adapter portion and a second adapter portion, the first adapter portion being attachable to the free-end portion of the cable insulation using compression and thereby forming a compression zone whereat the cable insulation is moved inward by the first adapter portion toward the electrical conductor, the compression zone having a longitudinally outward end portion located along the cable insulation toward a longitudinally outward end portion of the first adapter portion and a longitudinally inward end portion located along the cable insulation toward a longitudinally inward end portion of the first adapter portion, and the second adapter portion being attachable to the electrical connector; and
a flow channel positioned within the injection adapter between the first adapter portion and the electrical conductor at the free-end portion of the cable insulation, with a flow channel longitudinally outward end portion located toward the longitudinally outward end portion of the first adapter portion and a flow channel longitudinally inward end portion located toward the longitudinally inward end portion of the first adapter portion such that when the first adapter portion is attached to the free-end portion of the cable insulation using compression, the flow channel will provide a flow path for injected treatment fluid through at least a portion of the compression zone.

2. The injection connector of claim 1, wherein the flow channel is tube.

3. The injection connector of claim 1, for use with a cable having a recess between the first adapter portion and the electrical conductor at the free-end portion of the cable insulation sized to receive the flow channel, wherein the longitudinally inward end portion of the flow channel is blunt.

4. The injection connector of claim 1, wherein the longitudinally inward end portion of the flow channel is beveled.

5. The injection connector of claim 1, wherein the flow channel is positioned between the electrical conductor and the cable insulation.

6. The injection connector of claim 1, wherein the flow channel is positioned between the electrical conductor and an inner surface of the cable insulation.

7. The injection connector of claim 1, wherein the flow channel is positioned at an interface between the electrical conductor and the cable insulation.

8. The injection connector of claim 1, wherein the flow channel is positioned laterally outward of the electrical conductor.

9. The injection connector of claim 1, for use with a cable having a drilled hole extending longitudinal within the electrical conductor, wherein the flow channel is positioned within the drilled hole.

10. The injection connector of claim 9, wherein when positioned within the drilled hole, the flow channel extends between the longitudinally outward end portion of the first adapter portion and the longitudinally inward end portion of the first adapter portion.

11. The injection connector of claim 1, for use with a cable having a conductor shield, wherein the flow channel is positioned between the electrical conductor and an inner surface of the conductor shield.

12. The injection connector of claim 1, for use with a cable having a conductor shield, wherein the flow channel is positioned at an interface between the electrical conductor and the conductor shield.

13. The injection connector of claim 1, wherein the flow channel provides unrestricted fluid communication between the longitudinally outward end portion of the first adapter portion and the longitudinally inward end portion of the first adapter portion.

14. The injection connector of claim 1, wherein the injection adapter further includes a third adapter portion defining an adapter interior cavity located between the first and second adapter portions and an adapter injection port providing fluid communication between an exterior of the injector adapter and the adapter interior cavity to permit a flow of injected treatment fluid into the adapter interior cavity, the adapter interior cavity being in fluid communication with the flow channel.

15. The injection connector of claim 1, wherein the flow channel has an inner diameter of at least 0.01 inches.

16. The injection connector of claim 1, wherein the flow channel has an outer diameter of no more than 57% of the thickness of the cable insulation.

17. An injection connector for injection of a treatment fluid for rejuvenating a flow restricted cable having an electrical conductor comprised of a plurality of conductor strands with interstitial volume therebetween blocked by a PIB-based mastic or another restriction, the electrical conductor being surrounded by a polymeric cable insulation and having a free-end portion extending outward beyond a free-end portion of the cable insulation for attachment to an electrical connector, comprising:
an injection adapter having a first adapter portion and a second adapter portion, the first adapter portion being attachable to the free-end portion of the cable insulation using compression and thereby forming a compression zone whereat the cable insulation is moved inward by the first adapter portion toward the electrical conductor, the compression zone having a longitudinally outward end portion located along the cable insulation toward a longitudinally outward end portion of the first adapter portion and a longitudinally inward end portion located along the cable insulation toward a longitudinally inward end portion of the first adapter portion, and the second adapter portion being attachable to the electrical connector; and
a flow channel positioned within the injection adapter between the first adapter portion and the electrical conductor at the free-end portion of the cable insulation, with a flow channel longitudinally outward end portion located toward the longitudinally outward end portion of the compression zone and a flow channel longitudinally inward end portion located toward the longitudinally inward end portion of the compression zone such that when the first adapter portion is attached to the free-end portion of the cable insulation using compression, the flow channel will provide a flow path for injected treatment fluid through at least a portion of the compression zone.

18. An injection connector for injection of a treatment fluid for rejuvenating a flow restricted cable having an electrical conductor comprised of a plurality of conductor strands with interstitial volume therebetween blocked by a PIB-based mastic or another restriction, the electrical conductor being surrounded by a polymeric cable insulation and having a free-end portion extending outward beyond a free-end portion of the cable insulation for attachment to an electrical connector, comprising:
an injection adapter having a first adapter portion and a second adapter portion, the first adapter portion being attachable to the free-end portion of the cable insulation using compression and thereby forming a compression zone whereat the cable insulation is moved inward by the first adapter portion toward the electrical conductor, the compression zone having a longitudinally outward end portion located along the cable insulation toward a longitudinally outward end portion of the first adapter portion and a longitudinally inward end portion located along the cable insulation toward a longitudinally inward end portion of the first adapter portion, and the second adapter portion being attachable to the electrical connector; and
a collar positioned within the injection adapter between the electrical conductor and the cable insulation at the free-end portion of the cable insulation, the collar having an interior collar passageway sized to receive the electrical conductor therethrough, with a collar longitudinally outward end portion located toward the longitudinally outward end portion of the first adapter portion and a collar longitudinally inward end portion located toward the longitudinally inward end portion of the first adapter portion such that when the first adapter portion is attached to the free-end portion of the cable insulation using compression, the interior collar passageway will provide a flow path for injected treatment fluid through at least a portion of the compression zone.

19. The injection connector of claim 18, for use with a cable having a conductor shield, wherein the collar is positioned between the electrical conductor and an inner surface of the conductor shield.

20. The injection connector of claim 18, wherein the longitudinally inward end portion of the collar is tapered.

21. The injection connector of claim 18, for use with a cable having an annular drilled hole extending longitudinal within the cable insulation and laterally outward of the electrical conductor, wherein the collar is positioned within the annular drilled hole.

22. The injection connector of claim 21, wherein when positioned within the annular drilled hole, the collar extends between the longitudinally outward end portion of the first adapter portion and the longitudinally inward end portion of the first adapter portion.

23. The injection connector of claim 18, for use with a cable having a conductor shield extending about the electrical conductor, wherein the collar has an exterior diameter sufficient to separate the electrical conductor from the conductor shield and provide a flow path between the electrical conductor and the conductor shield for injected treatment fluid through at least a portion of the compression zone.

24. The injection connector of claim 18, wherein the longitudinally inward end portion of the collar is chamfered.

25. The injection connector of claim 18, wherein the collar includes a longitudinal split allowing the cross-sectional size of the collar to be increased to accommodate multiple diameter size conductor strands.

26. The injection connector of claim 18, wherein at least one of the collar longitudinally outward end portion and the collar longitudinally inward end portion has one or more notches sized to reduce flow restriction when positioned against the cable insulation or the electrical connector.

27. The injection connector of claim 18, wherein the collar is positioned concentric with and adjacent to the electrical conductor.

28. An injection connector for injection of a treatment fluid for rejuvenating a flow restricted cable having an electrical conductor comprised of a plurality of conductor strands with interstitial volume therebetween blocked by a PIB-based mastic or another restriction, the electrical conductor being surrounded by a polymeric cable insulation and having a free-end portion extending outward beyond a free-end portion of the cable insulation for attachment to an electrical connector, comprising:
an injection adapter having a first adapter portion and a second adapter portion, the first adapter portion being attachable to the free-end portion of the cable insulation using compression and thereby forming a compression zone whereat the cable insulation is moved inward by the first adapter portion toward the electrical conductor, the compression zone having a longitudinally outward end portion located along the cable insulation toward a longitudinally outward end portion of the first adapter portion and a longitudinally inward end portion located along the cable insulation toward a longitudinally inward end portion of the first adapter portion, and the second adapter portion being attachable to the electrical connector; and
a collar positioned within the injection adapter between the electrical conductor and the cable insulation at the free-end portion of the cable insulation, the collar having an interior collar passageway sized to receive the electrical conductor therethrough, with a collar longitudinally outward end portion located toward the longitudinally outward end portion of the compression zone and a collar longitudinally inward end portion located toward the longitudinally inward end portion of the compression zone such that when the first adapter portion is attached to the free-end portion of the cable insulation using compression, the interior collar passageway will provide a flow path for injected treatment fluid through at least a portion of the compression zone.

29. An injection connector for injection of a treatment fluid for rejuvenating a flow restricted cable having an electrical conductor comprised of a single conductor strand blocked by a PIB-based mastic or another restriction, the electrical conductor being surrounded by a polymeric cable insulation and having a free-end portion extending outward beyond a free-end portion of the cable insulation for attachment to an electrical connector, comprising:
an injection adapter having a first adapter portion and a second adapter portion, the first adapter portion being attachable to the free-end portion of the cable insulation using compression and thereby forming a compression zone whereat the cable insulation is moved inward by the first adapter portion toward the electrical conductor, the compression zone having a longitudinally outward end portion located along the cable insulation toward a longitudinally outward end portion of the first adapter portion and a longitudinally inward end portion located along the cable insulation toward a longitudinally inward end portion of the first adapter portion, and the second adapter portion being attachable to the electrical connector; and
a flow channel positioned within the injection adapter between the first adapter portion and the electrical conductor at the free-end portion of the cable insulation, with a flow channel longitudinally outward end portion located toward the longitudinally outward end portion of the first adapter portion and a flow channel longitudinally inward end portion located toward the longitudinally inward end portion of the first adapter portion such that when the first adapter portion is attached to the free-end portion of the cable insulation using compression, the flow channel will provide a flow path for injected treatment fluid through at least a portion of the compression zone.

30. The injection connector of claim 29, wherein the flow channel is tube.

31. An injection connector for injection of a treatment fluid for rejuvenating a flow restricted cable having an electrical conductor comprised of a single conductor strand blocked by a PIB-based mastic or another restriction, the electrical conductor being surrounded by a polymeric cable insulation and having a free-end portion extending outward beyond a free-end portion of the cable insulation for attachment to an electrical connector, comprising:
an injection adapter having a first adapter portion and a second adapter portion, the first adapter portion being attachable to the free-end portion of the cable insulation using compression and thereby forming a compression zone whereat the cable insulation is moved inward by the first adapter portion toward the electrical conductor, the compression zone having a longitudinally outward end portion located along the cable insulation toward a longitudinally outward end portion of the first adapter portion and a longitudinally inward end portion located along the cable insulation toward a longitudinally inward end portion of the first adapter portion, and the second adapter portion being attachable to the electrical connector; and
a flow channel positioned within the injection adapter between the first adapter portion and the electrical conductor at the free-end portion of the cable insulation, with a flow channel longitudinally outward end portion located toward the longitudinally outward end portion of the compression zone and a flow channel longitudinally inward end portion located toward the longitudinally inward end portion of the compression zone such that when the first adapter portion is attached to the free-end portion of the cable insulation using compression, the flow channel will provide a flow path for injected treatment fluid through at least a portion of the compression zone.

32-61. (canceled)
